(19) United States
(12) Patent Application Publication
(10) Pub. No.: US 2022/0334800 A1
(43) Pub. Date: Oct. 20, 2022

(54) EXACT STOCHASTIC COMPUTING MULTIPLICATION IN MEMORY

(71) Applicant: UNIVERSITY OF LOUISIANA AT LAFAYETTE, Lafayette, LA (US)

(72) Inventors: Mohammadhassan Najafi, Lafayette, LA (US); Mohsen Riahi Alam, Lafayette, LA (US); Nima TaheriNejad, Lafayette, LA (US)

(73) Assignee: UNIVERSITY OF LOUISIANA AT LAFAYETTE, Lafayette, LA (US)

(21) Appl. No.: 17/723,793

(22) Filed: Apr. 19, 2022

Related U.S. Application Data
(60) Provisional application No. 63/177,014, filed on Apr. 20, 2021.

(51) Int. Cl. G06F 7/523

(52) U.S. Cl. CPC G06F 7/523

(57) ABSTRACT

The multiplication method disclosed herein benefits from the complementary advantages of both Stochastic Computing (SC) and memristive In-Memory Computation (IMC) to enable energy-efficient and low-latency multiplication of data. In summary, the following method are disclosed. (a) Performing deterministic and accurate bit-stream-based multiplication in memory. To this end, the invention disclosed herein uses memristive crossbar memory arrays and Memory-Aided Logic (MAGIC). (b) Using an efficient in-memory method for generating deterministic bit-streams from binary data, which takes advantage of inherent properties of memristive memories. (c) Improving the speed and reducing the memory usage as compared to the State-of-the-Art (SoA) limited-precision in-memory binary multipliers. (d) Reducing latency and energy consumption compared to the SoA accurate off-memory SC multiplication techniques.

### CROSS REFERENCE TO RELATED APPLICATIONS

This application claims priority to U.S. Provisional Application No. 63/177,014 titled EXACT STOCHASTIC COMPUTING MULTIPLICATION IN MEMORY, filed on Apr. 20, 2021.

### STATEMENT REGARDING FEDERALLY SPONSORED RESEARCH OR DEVELOPMENT

This invention was supported in part by National Science Foundation Grant No. 2019511.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Exact Stochastic Computing Multiplication in Memory, which may be embodied in various forms. It is to be understood that in some instances, various aspects of the invention may be shown exaggerated or enlarged to facilitate an understanding of the invention. Therefore, the drawings may not be to scale.

FIG. 1 shows an example of multiplying two input values, ¼ and ¾, using the Low-Discrepancy (LD) deterministic method of SC. The inputs are converted to independent LD bitstreams using a bit-stream generation method.

FIG. 2 shows how NOR logic operation can be executed within the memory in MAGIC by applying specific voltages to the input(s) and output memristors. More specifically, FIG. 2(a) depicts performing a MAGIC NOR operation within a memristive memory, FIG. 2(b) shows a NOR truth table, and FIG. 2(c) depicts performing AND operation using MAGIC NOR within crossbar memristive memory array.

FIG. 3(a) shows the sub-computations of a 3-input 2-bit precision multiplication using the LD method. FIG. 3(a) depicts symbolic operations and FIG. 3(b) depicts effective operations in memory. Inputs are A= 2/4, B=¾, and C= 2/4 in binary format, and the output is bit-stream S representing 12/64. Only 27 out of 64 operations are performed in memory. The inputs are converted from binary to LD bit-streams based on the LD distributions.

FIG. 4(a) depicts XOR and AND operations using NOR gates. FIG. 4(b) depicts our novel method for 8-bit bit-stream (S7-S0) to 3-bit binary (Q2Q1Q0) conversion. Each square represents an AND operation and each circle represents an XOR operation.

FIG. 5 depicts the simulation output of the first two rows of the crossbar in the example of FIG. 3(b).

### I. INTRODUCTION

Transferring data between memory and processing units in conventional computing systems is expensive in terms of energy and latency. It also constitutes the performance bottleneck, also known as Von-Neumann's bottleneck. Memristors offer a promising solution by tackling this challenge via In-Memory Computation (IMC), i.e., the ability to both store and process data within memory cells. One promising in-memory logic for IMC is Memristor-Aided Logic (MAGIC). In MAGIC, NOR and NOT logical operations can be natively executed within memory and with a high degree of parallelism. Thus, applications such as Stochastic Computing (SC) that execute the same instruction on multiple data in parallel can benefit greatly from MAGIC.

Multiplication is a common but complex operation used in many data-intensive applications such as digital signal processing and convolutional neural networks. In-memory methods for fixed-point binary multiplication using MAGIC have been previously investigated. These methods are faster and more energy-efficient than conventional off-memory binary multipliers. However, memristive technology is not a fully mature technology yet, in particular, compared to Complementary Metal-Oxide Semiconductor (CMOS) technology. It suffers from considerable process variations and nonidealities that affect its performance. These nonidealities can lead to introduction of faults and noise into the memristive memory and in-memory calculations. The inherent vulnerability of fixed-point binary methods to fault and noise (e.g., to bit flips) poses a challenge to the reliability of the system.

Stochastic Computing (SC) is a re-emerging computing paradigm that offers simple execution of complex arithmetic functions. The paradigm is more robust against fault and noise compared to conventional binary computing. Multiplication, as a complex operation in conventional binary designs, can be implemented using simple standard AND gates in SC. Input data is converted from binary to independent (uncorrelated) bit-streams and connected to the inputs of the AND gate. Logical is are produced at the output of the gate with a probability equal to the product of the input data. An important overhead of performing computation in the stochastic domain is the cost of converting data between binary and stochastic representation. Prior works have exploited the intrinsic nondeterministic properties of memristors to generate random stochastic bit-streams in memory.

The bit-stream generation and the computation performed, however, are both probabilistic and approximate. Often very long bit-streams must be processed to produce acceptable results. These make the prior SC-based in-memory multipliers inefficient compared to their fixed-point binary counterparts. In this invention, to the best of our knowledge, we develop the first exact SC-based in-memory multiplier. The proposed multiplier can perform fully accurate multiplication, replacing the conventional binary multiplier, when needed. To this end, we exploit the recent progress in SC: deterministic and accurate computation with stochastic bit-streams.

The proposed multiplication method benefits from the complementary advantages of both SC and memristive IMC to enable energy-efficient and low-latency multiplication of data. In summary, the main contributions of this work are as follows: (a) Performing deterministic and accurate bit-stream-based multiplication in memory. To this end, we propose using memristive crossbar memory arrays and MAGIC. (b) Proposing an efficient in-memory method for generating deterministic bit-streams from binary data, which takes advantage of inherent properties of memristive memories. (c) Improving the speed and reducing the memory usage as compared to the State-of-the-Art (SoA) limited-precision in-memory binary multipliers. (d) Reducing latency and energy consumption compared to the SoA accurate off-memory SC multiplication techniques.

### II. BACKGROUND

A. Deterministic Computation with Stochastic Bit-Streams

In SC, data is represented by streams of 0s and 1s. Independent of the length and distribution of 1s, the ratio of the number of 1s to the length of the bit-stream determines the data value. For example, bit-streams 0100 and 11000000 both represent 0.25 in the stochastic domain. Compared to conventional binary radix, this form of representation is more noise-tolerant as all bits have equal weight. A single bit-flip, regardless of its position in the bit-stream, introduces a least significant bit error.

Deterministic approaches of SC were proposed recently to perform accurate computation with SC circuits. By properly structuring bit-streams, these methods are able to produce exact (fully accurate) output. Clock dividing bit-streams, using bit-streams with relatively prime lengths, rotation of bitstreams, and using low-discrepancy (LD) bit-streams are the primary deterministic methods. Compared to conventional SC, with these methods, the bit-stream length is reduced by a factor of approximately (½^{N}) where N is the equivalent number of bits precision. The output bit-stream produced by all these methods has the same length of 2^{i×N} bits, when multiplying i N-bit precision data. Due to the fast converging property of LD bit-streams, we use the LD deterministic approach to process bit-streams in memory. However, the proposed idea is applicable to all deterministic methods.

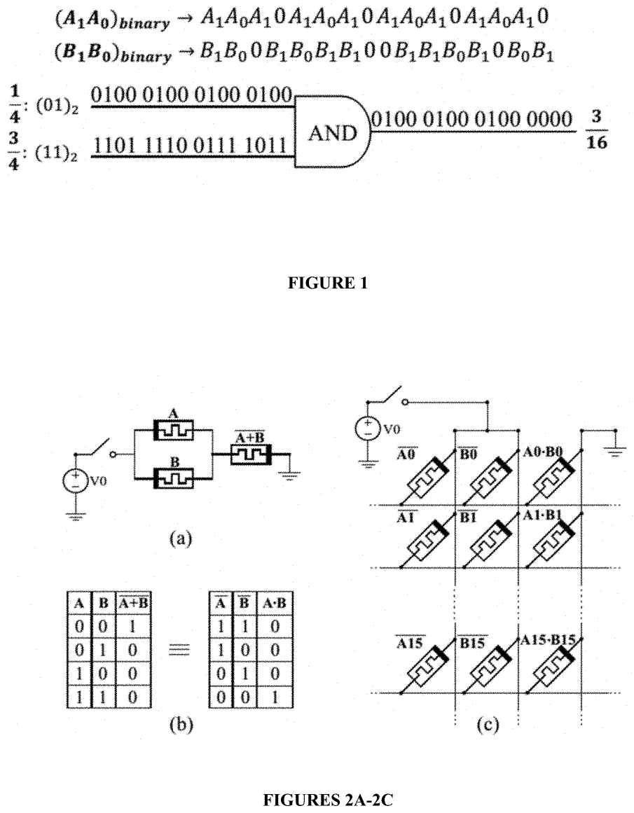

FIG. 1 shows an example of multiplying two input values, ¼ and ¾, using the LD deterministic method. With the LD method, the inputs are converted to independent bit-streams by using different LD distributions. Here, we use an algorithm known to those skilled in the art to determine the bit selection order for converting each binary input to the bit-stream format. The bit selection orders are determined based on the distribution of numbers in different Sobol sequences. The output bit-stream of the example in FIG. 1 is a 16-bit bit-stream representing 3/16, the exact result expected for multiplication of the two inputs. In general, when multiplying two N-bit precision data, the full-precision output bit-stream has a total length of 2^{2N} bits. This corresponds to a total processing time of 2^{2N} clock cycles when producing one bit of the output bitstream at any cycle.

Comparator-based, and MUX-based bit-stream generators are proposed in prior work to convert the data from binary to bit-stream representation. The overhead cost of conversion and the latency of generating and processing bitstreams make the conventional SC multiplier energy-inefficient compared to its binary counterpart. The large overhead of reading/storing data from/to memory further makes the conventional off-memory stochastic and binary multipliers inefficient compared to the emerging in-memory multipliers.

### B. Stochastic Computing and Memristors

Others skilled in the art exploit the intrinsic non-deterministic properties of memristors to generate random stochastic bit-streams in memory. They develop a hybrid system that consists of memristors integrated with CMOS-based stochastic circuits. Analog input data are converted to random bit-streams by a stochastic group writing into the memristive memory. The computation is performed on the bit-streams off-memory using CMOS logic and the output bit-stream is written back to the memristive memory. In every write to the memristive memory, a new random bit-stream is produced. The design eliminates the large overhead of off-memory stochastic bit-stream generation. Their bit-stream generation process, however, can be affected by variation and noise, and the computation is approximate.

Others skilled in the art have proposed a flow-based in-memory SC architecture. Their design exploits the flow of current through probabilistically-switching memristive nano switches in high-density crossbars to perform stochastic computations. The data is represented using bit-vector stochastic streams of varying bit-widths instead of traditional stochastic streams composed of individual bits. The crossbar computation performed in those designs is again approximate and probabilistic. Such designs cannot produce accurate results and must generate and process very long bit-streams.

In the instant invention, we propose a crossbar-compatible SC-based multiplier to perform deterministic and accurate multiplication in memory. We propose a new method to convert input binary data into deterministic bit-streams and employ SC to multiply the data by ANDing the generated bit-streams. Both the bitstream generation and the logical operation on the generated bit-streams will be performed in memory.

### C. Memristive In-Memory Computation

Memristors are two-terminal electronic devices with variable resistance. This resistance depends on the amount and direction of the charge passed through the device in the past. For stateful IMC, we treat this resistance as the logical state, where the high and low resistances are considered, respectively, as logical zero and one. MAGIC is a well-known stateful logic family proposed for IMC. It is fully compatible with the usual crossbar design and supports NOR, which can be used to implement any Boolean logic. FIG. 2 shows how NOR logic operation can be executed within the memory in MAGIC by applying specific voltages to the input(s) and output memristors. As shown in FIG. 2 and the embedded truth tables, performing logical NOR on negated version of two inputs (i.e., A+B) is equivalent to performing logical AND on the original inputs (i.e., A B).

We exploit this logical property to implement AND operation in memory. Others skilled in the art proposed a fixed-point MAGIC-based multiplication algorithm by serializing the addition of partial products in memory. An N-bit fixed-point multiplication with their method takes 15N²−11N−1 cycles and 15N²−9N−1 memristors. Others skilled in the art have proposed an improved method to perform fixed point multiplication within memristive memory using MAGIC gates. To multiply two numbers they use the partial product multiplication algorithm and reuse the memristor cells during execution. A two-input full-precision multiplication (the output has twice the precision/length of the inputs) using this method needs 13N²−14N+6 cycles and 20N−5 memristors. They also propose a limited-precision multiplication (the output has the same precision/length as the inputs) by generating and accumulating only the necessary partial products to produce the lower half (less significant bits) of the full-precision product. This improves latency by approximately 2×. The latency is reduced to 6.5N²−7.5N−2 cycles while 19N−19 memristors are required. The limited precision multiplication is especially useful for digital signal processing and fixed-point design of neural networks. Others skilled in the art have introduced a fast and low-cost full-precision in-memory multiplier, which performs two-input multiplication using 2N²+N+2 memristors in [log₂ N] (10N+2)+4N+2 cycles.

### III. THE NOVEL METHOD

The instant invention, a method of exact SC-based multiplication in memristive memory, will now be described. We assume that the input data is already in memory in binary-radix format. We convert the data from binary to bit-stream representation in memory, process using stateful logic, and then convert the result back to binary format.

### A. Binary to Bit-Stream

The prior art has exploited the probabilistic properties of memristors to generate random bit-streams in memory. The bit-streams generated by these methods suffer from random fluctuations and cannot produce accurate results. For accurate i-input multiplication, the input binary data must be converted to i 2^{(i×N)}-bit independent bit-streams. With the LD deterministic method, the independence between bit-streams is guaranteed by converting each input data based on a different LD sequence. We convert the data to LD bit-streams by using the LD distributions known by those skilled in the art.

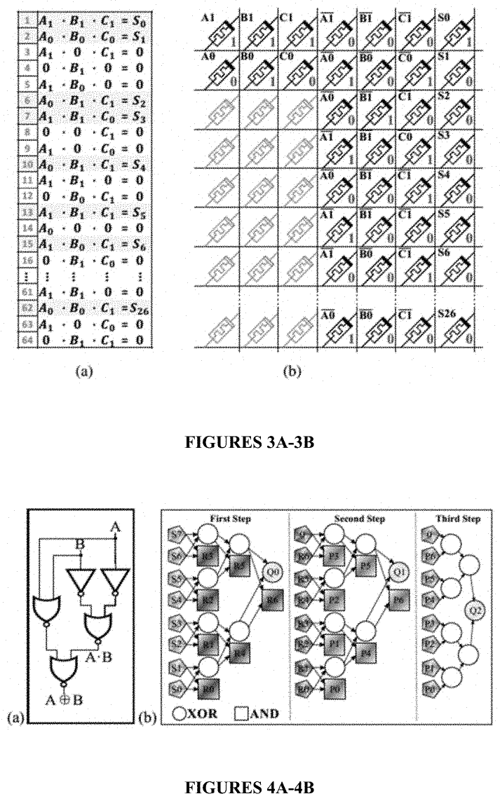

FIG. 3(a) shows the sub-computations of a 3-input 2-bit precision multiplication using the LD method. As it can be seen, out of 64 operations only 27 operations can produce a non-zero output and contribute to the final result. This stems from the fact that the maximum value representable by a 2-bit precision data and the maximum result of multiplying three 2-bit data is ¾ and 27/64, respectively. In the general case, in an i-input N-bit precision multiplication, (2^{N}−1)ⁱ bitwise AND operations contribute to the output value. The in-memory multiplier only performs these operations. To achieve high-performance multiplication within memristive memory, we perform these bitwise operations in a parallel manner.

For multiplication discussed above, we need the generated bit-stream to be stored in a column (as opposed to a row). To this end, we use external CMOS switches to connect binary input memristors (e.g., Aⱼ, Bⱼ, Cⱼ) to respective bitstream memristors in different rows. A CMOS control circuitry controls the connection of switches. Because memristors are CMOS compatible and can be produced as Back End Of Line (BEOL), these external switches can be placed below the memristor crossbar to avoid area overhead. Moreover, our synthesis results show that the overhead power and energy consumption of the control circuitry is negligible compared to the IMC operations of the multipliers themselves.

To convert each input data, we first initialize (2^{N}−1)ⁱ memristors in a column (e.g., the fourth column in FIG. 3.(b)), to Low Resistance State (LRS) or logical value of ‘1’. For conversion, we apply V₀ to the negative terminal of the input binary memristors (e.g., Aⱼ), which is connected to respective memristors in the bit-stream column. If Aⱼ is storing a logical ‘0’, i.e., it is in High Resistance State (HRS), it is virtually open circuit. Thus, the connected memristors see no voltage and will not change their state. If Aⱼ stores ‘1’, it is in LRS and acts as a virtual short circuit. Thus, all memristors connected to it see a V₀ across themselves.

By selecting V₀ large enough, all respective memristors experience a state change from LRS to HRS. In other words, from logical ‘1’ (their initial value) to logical ‘0’. Therefore, at the end of the conversion operation, the bit-stream memristors corresponding to a binary input bit of ‘1’ will have a logical value of ‘0’, and vice-versa (i.e., ‘0’→‘1’). We note that this representation is complementary to (i.e., it is the inverted version of) conventional bit-stream representation. However, this inversion—as we show later—is advantageous as it reduces the number of steps necessary to perform a multiplication.

B. Stochastic Multiplication using MAGIC

We convert each N-bit binary data to a (2^{N}−1)² bit bitstream for two-input exact (full-precision) and to a (2^{N}−1) bit bit-stream for limited-precision multiplication. The multiplication consists of a bitwise AND operation between the two operands. However, in MAGIC, which we have chosen for this work, the only operation compatible with crossbar memory is NOR. Therefore, we need to use an equivalency, namely,

A∧B=Ā̅∨̅B̅. Equation (1)

As we see in Equation (1), to perform AND in MAGIC, the input operands need to be inverted, followed by a NOR operation. Therefore, our proposed method has the advantage that by generating the bit-streams already in their inverted form, as explained in Section III-A, we save two steps (one for inversion of each operand). Hence, the proposed multiplication here consists of only one MAGIC NOR operation between the two bit-stream operands. To perform the multiplication, i.e., MAGIC NOR, the two operands need to be connected in a row as shown in FIG. 2(c). That is, for this operation, each corresponding bit of the two operands need to be in the same row, which is one of the reasons why bit-streams are generated in columns (as opposed to rows). The proposed design can be extended to i-input multiplication by performing i-input MAGIC NOR on i bit-stream operands. Converting each operand needs one initialization and one execution cycle.

The NOR operation also takes one initialization and one execution cycle. To decrease sneak paths, we perform these initializations in different cycles. This makes the total latency of i-input multiplication 2×(i+1) cycles. FIG. 3 shows an example of a 3-input 2-bit precision multiplication using the proposed method. We will show that this 3-input multiplication is executed in eight cycles.

### C. Bit-Stream to Binary

After performing multiplication using MAGIC, the output is in memory in the bit-stream format. The output bit-stream can be preserved in memory in the current format for future bit-stream-based processing. However, if an output in binary format is desired, a final bit-stream-to-binary step is also needed. This can be done by counting the number of is in the bit-stream by adding all the bits of the bit-stream. We suggest two methods to convert the output bit-stream to binary representation, in-memory conversion and off-memory conversion.

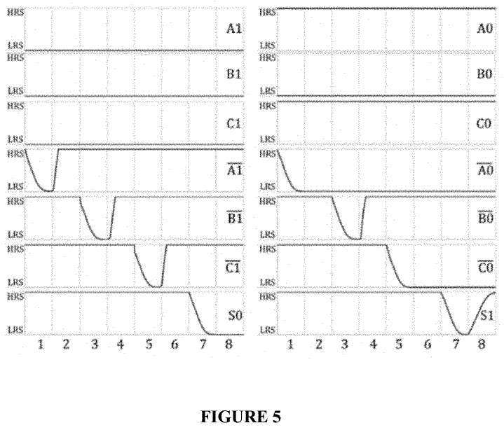

(1) In-memory conversion. Disclosed herein is a new method for counting all the ‘1’s of a bit-stream in memory. FIG. 4(b) depicts the new method for converting an 8-bit bit-stream to 3-bit binary data. The method consists of AND and XOR operations. As shown in FIG. 4(a), every pair of AND and XOR operations is implemented with three NOR and two NOT MAGIC operations. We re-use memristors to minimize the number of required memristors in implementing this in-memory conversion. This algorithm can be easily extended to convert longer bit-streams. It takes 4×(log₂ L)² cycles to count the number of ‘1’s in a bit-stream of length L. The two-input full-precision and the limited-precision multiplication require 0.5×(2^{N}−1)²+N and 0.5×(2^{N}−1)+N additional memristors, respectively, for in-memory conversion using this method.

(2) Off-memory conversion. The output bit-stream (e.g., bitstream S in FIG. 3(b)) is read from the memory and its bits are summed using an off-memory combinational CMOS circuit. We described a sum function for adding L bits using Verilog HDL and let the synthesis tool find the best hardware design for summing those bits. The latency and hardware costs for conversion of output bit-streams with this method are extracted from synthesis reports and used for evaluation.

### IV. RESULTS AND COMPARISONS

### A. Circuit Level Simulations

For circuit-level evaluation of the proposed design, we implemented a 32×32 crossbar and necessary control signals in Cadence Virtuoso. For memristors, we used the Voltage-controlled ThrEshold Adaptive Memristor (VTEAM) model known to those skilled in the art. The values used for the parameters are

{Rₒₙ,R_{off}VTₒₙ,VT_{off},xₒₙ,x_{off},kₒₙ,k_{off},αₒₙ,α_{off}}={1 kΩ,300 kΩ,−1.5 V,300 mV,0 nm,3 nm,−216.2 m/sec,0.091 m/sec,4,4}.

FIG. 5 shows the states of the memristors in the first two rows of the example shown in FIG. 3(b). At first, all memristors (except the binary memristors holding the input data) are in HRS. To convert each input, we initialize the bit-stream memristors in the respective column to LRS using V_{SET}=2.08 V (cycles 1, 3, and 5 for initializing bit-streams of input A, B, and C, respectively). After initialization, we apply V₀=1.48V to binary memristors and GND to bit-stream memristors to generate the bit-streams (cycles 2, 4, and 6). The output memristors are initialized in the next cycle and V₀=1.08V is applied to execute the NOR operations (cycles 7 and 8). Based on the LRS to HRS switching time of a memristor, 1 ns was considered for time-length of each and every operation (i.e., voltage pulse-width is 1 ns).

TABLE 1
Latency and Area of the Two-Input Stateful
N-Bit Precision In-Memory Multiplcation

| | | Latency | Area |
|---|---|---|---|
| Methods | | (Cycles) | (# of memristors) |
| Full | Haj-Ali et al. | 13N² − 14N + 6 | 20N − 5 |
| Precision | Imani et al. | 15N² − 11N − 1 | 15N² − 9N − 1 |
| | Radakovits et al. | [log₂ N] (10N + 2) + 4N +2 | 2N² + N + 2 |
| | This work | 6 | 3 × (2^{N} − 1)² |
| Limited | Haj-Ali et al. | 6.5N² − 7.5N − 2 | 19N − 19 |
| Precision | This work | 6 | 3 × (2^{N} − 1) |

B. Comparison with In-Memory Binary Multiplication

Table I compares the latency (number of processing cycles) and the area (number of memristors) of the proposed bitstream-based multiplier with the prior in-memory fixed-point multiplication methods. As shown, the proposed multiplier is significantly faster than the prior in-memory binary methods by producing the output bit-stream in only six cycles. In terms of the area too, the proposed method is more efficient (requires a smaller number of memristors) for N<5 for the limited precision case. Compared to the limited-precision design known by those skilled in the art that produces the lower half (least significant bits), the instant method is more precise as it produces the higher half of the full precision result. For larger Ns, other design considerations regarding the trade-off between memory and area should be taken into account. In general, for an i-input full-precision multiplication, 3×(2^{N}−1) memristors are needed. If a binary output is desired, the additional latency and area of the bitstream-to-binary step must also be considered.

The inherent fault tolerance of the proposed design can still be a winning proposition for larger Ns as the nonidealities of memristive technology can lead to introduction of faults and noise into the memristive memory and in-memory calculations. The current accurate in-memory multiplication methods are all based on the conventional binary representation of data which makes them inherently more vulnerable to faults compared to the SC-based methods.

We note that the power consumption of various IMC units heavily depends on the memristive technology used for the implementation (or the model representing it) and its respective necessary setup. Therefore, to have a fair comparison with prior work, they need to be implemented using the same technology or simulated using the same model and model parameters.

C. Comparison with Off-Memory Stochastic Multiplication

For an off-memory SC-based multiplication of N-bit binary data, the data must be first read from the memory and be converted from binary to bit-stream representation. The clock division method known by those skilled in the art has the lowest hardware cost among the SoA deterministic methods of SC. We implemented a clock division circuit known by those skilled in the art to convert the data and generate bitstreams. Multiplication is performed by ANDing the generated bit-streams. The output is converted back to binary format using a binary counter and is stored in memory. We described this off-memory design using Verilog HDL and synthesized it using the Synopsys Design Compiler v2018.06-SP2 with the 45 nm NCSU-FreePDK gate library.

TABLE II
ENERGY CONSUMPTION RESULTS ( )N PJ) COMPARISON OF THE PROPOSED METHOD
AND OFF-MEMORY EXACT SC-BASED MUTIPLICATION

| | Limited Precision | | | | | | | Full Precision | | | | | | |
|---|---|---|---|---|---|---|---|---|---|---|---|---|---|---|
| Design Method | N = 2 | 3 | 4 | 5 | 6 | 7 | 8 | 2 | 3 | 4 | 5 | 6 | 7 | 8 |
| This work | 0.026 | 0.061 | 0.13 | 0.27 | 0.55 | 1.12 | 2.24 | 0.08 | 0.43 | 1.98 | 8.47 | 35 | 142 | 573 |
| (no bit-stream-to- | | | | | | | | | | | | | | |
| binary conversion) | | | | | | | | | | | | | | |
| This work | 0.035 | 0.09 | 0.21 | 0.47 | 1.01 | 2.17 | 4.62 | 0.12 | 0.77 | 3.1 | 19 | 87 | 386 | 1087 |
| (+ in-memory | | | | | | | | | | | | | | |
| bit-stream-to-binary) | | | | | | | | | | | | | | |
| This work | 7 | 15 | 29 | 56 | 108 | 210 | 413 | 20 | 86 | 366 | 1,529 | 6,263 | 25,166 | 101,391 |
| (+ off-memory bit- | | | | | | | | | | | | | | |
| stream-to-binary) | | | | | | | | | | | | | | |
| Off-Memory Exact | 38 | 40 | 44 | 53 | 76 | 124 | 234 | 58 | 76 | 133 | 694 | 3,092 | 16,919 | 62,541 |
| SC-based multiplication | | | | | | | | | | | | | | |

Table II compares the energy consumption of the proposed in-memory multiplier with that of the implemented off-memory SC multiplier for data precision of two to eight bits. For the cases that include off-memory processing, we assume the data is read from or written to a memristive memory. We use the per-bit energy consumption known by those skilled in the art to calculate the total energy of the read and write operations. As shown in Table II, for all different Ns, the proposed in-memory design with in-memory bit-stream-to-binary conversion provides significantly lower energy consumption than the off-memory exact SC-based multiplier. For off-memory bitstream-to-binary conversion, the size of the data read from the memory plays a crucial role. Our work is more energy efficient for small Ns. However, for larger Ns the traditional CMOS off-memory SC consumes less energy. The reason is the size of the data read from the memory, which grows exponentially in the case of in-memory multiplication off-memory conversion (bit-streams are read), compared to the traditional off-memory SC computation (where binary data are read), giving the latter an edge.

### CONCLUSIONS

This instant invention disclosed herein is the first in-memory architecture to execute exact multiplication based on SC. The multiplication results are as accurate as the results from fixed-point binary multiplication. The proposed method significantly reduces the energy consumption compared to the SoA off-memory exact SC-based multiplier. Compared to prior in-memory fixed-point multiplication methods, the instant invention provides faster results. For smaller Ns, the area is comparable too. For larger Ns, the area is the price for the gained speed. In a particularly preferred embodiment, limited-precision multiplication is advantageous for applications such as neural networks and certain signal processing algorithms, since it is not only faster but also more precise and for the usually targeted Ns, area efficient.

If outputs are desired in binary format, a bit-stream-to-binary conversion overhead should be considered too. The instant invention employed an efficient crossbar compatible method for this conversion. The inherent noise-tolerance of bit-stream processing makes the proposed design further advantageous for memristive-based computation compared to its binary counterparts.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

1. A method of exact Stochastic Computing—based multiplication in memristive memory, comprising:
(1) providing input data in binary-radix format;
(2) converting the data to Low Discrepancy (LD) bit-streams by using LD distributions;
(3) performing multiplication by bitwise operations in a parallel manner;
(4) converting each N-bit binary data to a (2^{N}−1)² bit bitstream for two-input exact (full-precision) and to a (2^{N}−1) bit bit-stream for limited-precision multiplication;
(5) performing multiplication using Memory Aided Logic; and
(6) preserving the output in memory in bit-stream format.

2. The method of claim 1 further comprising converting the output from bit-stream format to binary format.

3. The method of claim 2 wherein the output is converted from bit-stream format to binary format using in-memory conversion.

4. The method of claim 2 wherein the output is converted from bit-stream format to binary format using off-memory conversion.

5. A method for converting an 8-bit bit-stream to 3-bit binary data wherein said method consists of AND and XOR operations and every pair of AND and XOR operations is implemented with three NOR and two NOT MAGIC operations.
